(19) United States
(12) Patent Application Publication
(10) Pub. No.: US 2006/0174492 A1
(43) Pub. Date: Aug. 10, 2006

(54) Reciprocating blade systeme for knives, enabling higher cutting efficiency without pulling on the object to be cut

(76) Inventor: Charles Gasman, Vincennes (FR)

Correspondence Address: Charles Gasman, 7bis rue de la Bienfaisance, 94300 Vincennes, France, FR

(21) Appl. No.: 10/535,251

(22) PCT Filed: Nov. 25, 2003
(86) PCT No.: PCT/FR03/03486

§ 371 Date: Nov. 30, 2005

(30) Foreign Application Priority Data
Dec. 17, 2002 (FR) 02/15984

(51) Int. Cl. B26B 29/00

(52) U.S. Cl. 30/294

(57) ABSTRACT

Reciprocating blade system for knives, employed in order to achieve a highly effective cutting action without dragging upon the object to be cut. The invention concerns a reciprocating blade system for knives characterized by a blade with curved or arc-shaped cutting edge capable of oscillating or swinging relative to the support whereto it is fixed by any means enabling said movement such that the cutting edge can operate a reciprocating rolling movement on the object to be cut when the handle is pushed backwards and forwards in the manner of a standard knife.

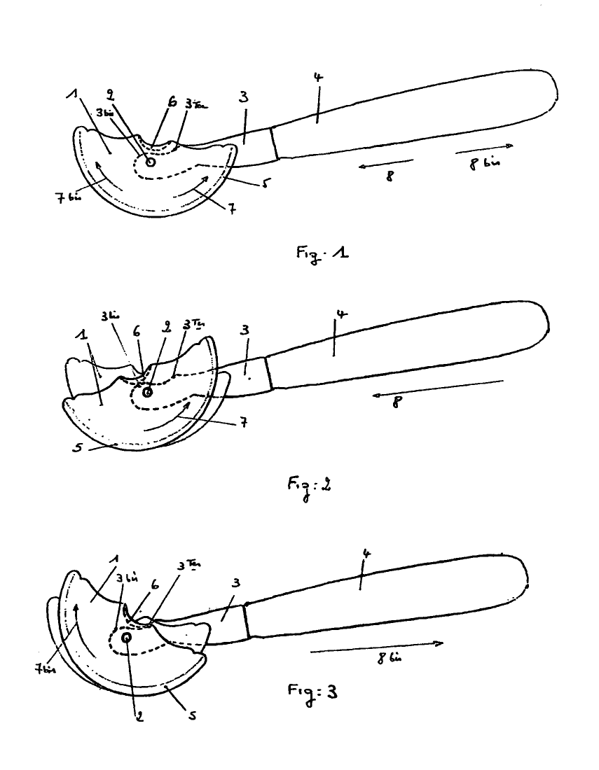

In the embodiment represented in FIG. 1, the blade (1) has an arc-shaped cutting edge (5) and is fixed to a support rod (3) extended by a handle (4), through a pin (2) which enables its oscillation along the arrows (7) and (7bis).

Thus, by setting the curved surface (5) of the blade (1) which forms the cutting edge and by pressing it on the object to be cut, a reciprocating movement imparted to the handle (4) along the arrows (8) and (8bis) as with any knife, is sufficient for causing the curved and cutting part (5) of the blade (1) to roll above it in one direction then in the other along the arrows (7) and (7bis) and cut with higher efficiency and without pulling the object to be cut. The blade (1) comprises a stop (6), which will brake its reciprocating movement at each stroke end in both directions, so that the cutting edge (5) always remains in contact with the object to be cut and prevent the blade (1) from partly or completely overturning.

Reciprocating blade system for knives, employed in order to achieve a highly effective cutting action without dragging upon the object to be cut.

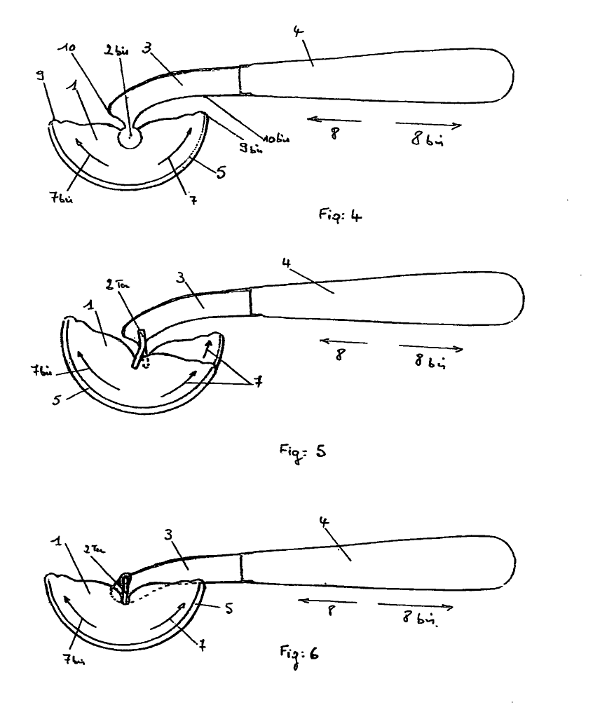

This present invention concerns a reciprocating blade system for knives, with curved or arc-shaped cutting edge, allowing high cutting efficiency to be achieved without dragging on the object to be cut, and requiring the user only to execute the same to-and-fro movement as for a conventional knife. It differs from blades which are circular, or which vary in circumference, of different shapes, rotating about an axis, in that it is similar to conventional blades but is characterised by a curved or arc-shaped cutting edge which has the ability to oscillate or to swing in relation to the support to which it is attached by any means which allows it to move in this way, so that the cutting edge is able to execute a to-and-fro movement on the object to be cut when the handle is moved from front to rear as for any knife. In the method of implementation illustrated in FIG. 1, the blade (1) has a cutting edge (5) in the form of a circular arc, and is attached to a support rod (3) extended by a handle (4), by an pin (2) which allows it to oscillate along arrows (7) and (7bis). The blade (1) includes a stop (6), which arrests its to-and-fro movement at the limit of each direction, when this stop comes up against parts (3bis) and (3ter) of the rod (3) (FIGS. 2 and 3), so that the cutting edge (5) still remains in contact with the object to be cut, and prevents the blade (1) from over-rotating either partially or completely. This stop can take various forms, being of concave shape in this case, which is opposite to the convex shape of the support rod (3) at this point, this having the advantage of softening the contact with parts (3bis) and (3ter) of the support rod. It can also be composed of a spring or of a soft material such as plastic or rubber. In the method of implementation illustrated in FIG. 4, amongst other possible means of attachment, the blade (1) is attached to the support rod (3) by a swivel (2bis) which also allows it to oscillate along arrows (7) and (7bis). This swivel may be an integral part of the support rod (3) as in FIG. 4, and act as a hinge in the blade (1), or can be an integral part of the blade (1), and act as a hinge in the support rod (3). In this event, there is no need to equip the blade (1) with a stop, since the to-and-fro movement will be stopped when the extremities (9) and (9bis) of the blade (1) come into contact with parts (10) and (10bis) of the rod (3). In the method of implementation illustrated in FIG. 5, amongst other possible means of attachment, the blade (1) is attached to the support rod (3) by a spring (2ter) which also allows it to oscillate along arrows (7) and (7bis). This spring (2ter) can be located in the extension of the support rod (3) as in figure or on the side of this support rod as in FIG. 6. Other arrangements of this spring are also possible. In all these cases, the cutting edge (5) of the blade (1), can be smooth, toothed or micro-toothed. Thus, by positioning the curved side (5) of the blade (1) which forms the cutting edge, and pressing it onto the object to be cut, one only has to execute a to-and-fro movement of the handle (4) along arrows (8) and (8bis), as with any other knife, so that the curved cutting-edge part (5) of the blade (1) rolls along it, in one direction and then the other, along arrows (7) and (7 bis), cutting in a highly effective manner and without dragging on the object one wishes to cut. The forward movement is detailed in FIG. 2, and the reverse movement in FIG. 3. By slightly displacing the pin (2) to the left of the arc forming the blade (1), the length of the cut is increased when the handle is drawn backwards and vice versa. The shape of the handle, and the system for fitting it, can be varied and in different materials without affecting the operation of the system. The support rod (3) and the handle (4), can also be manufactured as a single part. The blade (1) can be made from various materials such as steels, ceramics, etc. that are normally used for cutting-blades. However, given the efficiency of the system, it can also be made from plastic, especially when manufacturing inexpensive or disposable knives. The knives or tools equipped in this way are particularly effective and practical in all cases where one has to avoid dragging or disarranging the object to be cut. They make excellent individual table knives, especially for cutting foods in which hard parts alternate with parts that are soft or break up easily, such as pizzas, quiches, pies, etc.

1) Reciprocating blade system for knife, allowing high cutting efficiency to be achieved without dragging on the object to be cut, characterised by a blade with curved or arc-shaped cutting edge, able to oscillate or swing in relation to the support to which it is attached by any means which allows it to move in this way, so that the cutting edge is able to execute a to-and-fro movement on the object to be cut when the handle is moved from front to rear as for any knife, thus approaching the design of conventional blades and differing from blades which are circular or which vary in circumference and of different shapes rotating about an pin, while still having the advantages of the latter and avoiding their drawbacks.

2) Reciprocating blade system for knife, characterised in that the blade (1) with curved or arc-shaped cutting edge (5), is attached to a support (3) extended by a handle (4), amongst other possible means of attachment, by an pin (2) which allows it to oscillate or swing in relation to this support, so that this cutting edge executes a to-and-fro rolling motion along arrows (7) and (7bis) ( FIGS. 2 and 3) on the object to be cut, when the handle is moved from front to rear as when cutting with any other knife (FIGS. 1,2 and 3).

3) Knife according to either of the previous claims, characterised in that the blade (1), includes a stop (6), which arrests its to-and-fro movement at the limit of each direction, when this stop comes up against parts (3bis) and (3ter) of the rod (3) (FIGS. 2 and 3), so that the cutting edge (5) still remains in contact with the object to be cut, and prevents the blade (1) from over-rotating either partially or completely.

4) Knife according to claim 4, characterised in that the stop (6) can take various forms, and in particular the concave shape as described in FIGS. 2 and 3, which is opposite to the convex shape taken by the support rod (3) at this point, and having the advantage of softening the contact with parts (3bis) and (3ter) of the support rod.

5) Knife according to claims 4 and 5, characterised in that the stop (6) can also be composed of a spring or of a soft material such as plastic or rubber.

6) Knife according to any of the previous claims characterised in that the length of cut is increased when moving the handle to the rear by slightly displacing the pin (2) to the left of the arc formed by the blade, and vice versa.

7) Knife according to any of the previous claims, characterised in that, amongst other possible means of attachment, the blade (1) is attached to the support rod (3) by a swivel (2bis) which also allows it to oscillate along arrows (7) and (7bis) (FIG. 4). This swivel can be an integral part of the support rod (3) as in FIG. 4, and act as a hinge in the blade (1), or can form an integral part of the blade (1) and act as a hinge in the support rod (3). In this event, the extremities (9) and (9bis) of the blade (1) act as an end-stop, since the to-and-fro movement will be stopped when they come into contact with parts (10) and (10bis) of the rod (3).

8) Knife according to any of the previous claims, characterised in that, amongst other possible means of attachment, the blade (1) is attached to the support rod (3) by a spring (2 ter) in the extension of the support rod, which also allows it to oscillate along arrows (7) and (7bis) (FIG. 5).

9) Knife according to claim 10, characterised in that the spring (2ter) can be located on the side of this support rod, as shown in FIG. 6, or fitted in other ways.

10) Knife according to any of the previous claims, characterised in that the cutting edge (5) of the blade (1) can be smooth, toothed or micro-toothed.

11) Knife according to any of the previous claims, characterised in that the shape of the handle, and the system for fitting it, can be varied and in different materials without affecting the operation of the system. The support rod (3) and the handle (4), can also be manufactured in a single piece.

12) Knife according to any of the previous claims, characterised in that the blade (1) can be made from various materials such as steels, ceramics, etc., that are normally used for cutting blades.

13) Knife according to any of the previous claims, characterised in that the blade (1) can also be made from plastic materials, especially when manufacturing inexpensive and disposable knives.

14) Knife according to any of the previous claims, characterised in that, amongst other uses, it can be employed at table as an individual knife for the cutting of foods such as, pizza, pies, etc. in particular.
